(19) United States
(12) Patent Application Publication
(10) Pub. No.: US 2016/0275468 A1
(43) Pub. Date: Sep. 22, 2016

(54) ELECTRICITY CONSUMPTION BILLING METHOD

(71) Applicant: Luxul Technology Incorporation, New Taipei City (TW)

(72) Inventors: Cheng-Hung Pan, New Taipei City (TW); Perng-Fei Yuh, New Taipei City (TW); Chih-Hung Lin, New Taipei City (TW); Shiun-Shang Jan, New Taipei City (TW)

(21) Appl. No.: 14/715,883

(22) Filed: May 19, 2015

(30) Foreign Application Priority Data
Mar. 19, 2015 (TW) 104108725

(51) Int. Cl. G06Q 20/14; G06Q 50/06

(52) U.S. Cl. CPC G06Q 20/145; G06Q 50/06

(57) ABSTRACT

An electricity consumption billing method includes steps of mounting a power detection switch, recording a first average amount of electricity consumption of an electric appliance in a first time duration, recording a second average amount of electricity consumption of the electric appliance in a second time duration, and calculating an incentive amount according to the first average amount of electricity consumption and the second average amount of electricity consumption. An electric power company records the first and second average amounts of electricity consumption of the electric appliance and calculates a one-time additional incentive amount. When customers improve power utilization efficiency, not only can the amount of the electric bill be saved, but also the electric power company further offers the incentive amount to encourage customers to improve power utilization efficiency and reduce consumption of electric energy.

### BACKGROUND OF THE INVENTION

1. Field of the Invention

The present invention relates to a billing method and, more particularly, to an electricity consumption billing method and system for continuously managing electricity consumption of an electric appliance.

2. Description of the Related Art

Electric energy has become one of indispensable energy sources in daily life of modern people. Regardless of mobile phones, computers, lighting, air-conditioner, heater or subway, they all require electric energy for operation. Normally, electric energy can be generated and stored by electric power companies and distributed to premises of residential and commercial customers.

Due to insufficient power generation capacity, electric power companies may fail to meet the peak demand required by all their customers. To circumvent the power shortage during on-peak hours, power rationing needs to be exercised and customers' loss incurred during the power rationing become inevitable. Therefore, electric power companies seek solutions to lower the peak power demand as a measure of avoiding the chance of power rationing.

One of the approaches currently adopted by electric power companies is to set up different electricity rates for on-peak and off-peak hours with the off-peak rates cheaper than the on-peak rates such that customers can selectively schedule when to utilize power to reduce instantaneous load arising from simultaneous power demand.

However, the billing scheme created according to on-peak and off-peak hours are not so effective because of the electricity usage habits of customers. The reason resides in that customers can only benefit from the saved charge gained from reduced amount of electricity used in the on-peak hours and thus weakly encouraging the customers not to use electricity during the on-peak hours.

Electric power companies currently employ an incentive program offering energy efficiency incentives to customers. In addition to the saved charge, customers can also receive an incentive amount from the incentive program as a credit on customers' electric bills. As installing one electricity meter at the premise of one residential or commercial customer and billing the customer on a monthly basis, electric power companies can only acquire meter reading for current month and compare the meter reading for the current month with meter reading for a previous month to determine how much the incentive amount is.

However, such monthly billing period is sort of lengthy, and the consequence is that customers may just lower the total electricity usage for current month instead of improving electricity utilization efficiency. For example, in the event of a company outing, although the monthly electricity usage is reduced, such electricity usage reduction has no effect on improvement of electricity utilization efficiency. In reality, the electricity utilization efficiency can be improved in examples, such as an average power consumption of an air conditioner down by 20% after adjusting temperature of the air conditioner from 22 degrees to 25 degrees upon air-conditioning in summer. In other words, as the average power consumption is equal to a ratio of a consumed electricity amount to a period of time, if each customer improves the power utilization efficiency in the on-peak hours to lower the average power consumption of electric appliances, the total electricity usage amount in the on-peak hours can be lowered. Hence, electric power companies will offer incentives according to the degree of customer's improvement on the power utilization efficiency to encourage customers to improve power utilization efficiency in the on-peak hours and to reduce the overall consumed electricity amount during the on-peak hours.

As can be seen from the foregoing description, the current billing approach of electric power companies for monthly electricity usage can only acquire customers' total consumed electricity amount for current month instead of electricity amount consumed by customers in a specific period of time, that is, the average power consumption in the on-peak hours. When customers reduce the operation time of air-conditioners in the off-peak hours for current month, the total meter reading for current month detected by electric power companies is less than that for the previous month but the reduced total meter reading does not result from improvement on power utilization efficiency and provided no indication about whether power utilization efficiency has been improved.

### SUMMARY OF THE INVENTION

An objective of the present invention is to provide an electricity consumption billing method compensating customers upon improvement on power utilization efficiency and lessening customers' willingness to use electric appliances during on-peak hours.

To achieve the foregoing objective, the electricity consumption billing method comprises steps of:

mounting a power detection switch to detect an electric appliance;

using the power detection switch to detect a first average amount of electricity consumption of the electric appliance in a first time duration and transmitting the first average amount of electricity consumption to a server for storage;

using the power detection switch to detect a second average amount of electricity consumption of the electric appliance in a second time duration and transmitting the second average amount of electricity consumption to the server for storage, wherein the first average amount of electricity consumption is greater than the second average amount of electricity consumption; and

using the server to calculate an incentive amount according to the first average amount of electricity consumption and the second average amount of electricity consumption.

The first average amount of electricity consumption and the second average amount of electricity consumption of the electric appliance instead of a total amount of electricity consumption in a fixed time duration can be used as criteria to determine if the power utilization efficiency of the electric appliance has been improved. If the first average amount of electricity consumption in the first time duration is greater than the second average amount of electricity consumption in the second time duration, it indicates that the power utilization efficiency of the electric appliance has been improved in the second time duration. From the perspective of electric power companies, improvement on the power utilization efficiency of the electric appliance can be ascertained through the present invention. From the perspective of customers, after confirming that customers have improved the power utilization efficiency of the electric appliance, electric power companies will deduct the incentive amount from the amount of the electric bill upon collecting the payment of the electric bill. Therefore, customers' willingness to improve the power utilization efficiency can be promoted.

To achieve the foregoing objective, the electricity consumption billing method includes steps of:

mounting a power detection switch to detect a first electric appliance;

using the power detection switch to detect a first average amount of electricity consumption of the first electric appliance in a first time duration and transmitting the first average amount of electricity consumption to a server for storage;

replacing the first electric appliance with a second electric appliance;

using the power detection switch to detect a second average amount of electricity consumption of the second electric appliance in a second time duration and transmitting the second average amount of electricity consumption to the server for storage, wherein the first average amount of electricity consumption is greater than the second average amount of electricity consumption; and

using the server to calculate an incentive amount according to the first average amount of electricity consumption and the second average amount of electricity consumption.

The foregoing electricity consumption billing method allows customers to replace the first electric appliance with the second electric appliance and improves power utilization efficiency through the new second electric appliance. The power detection switch detects the first average amount of electricity consumption of the first electric appliance and the second average amount of electricity consumption of the second electric appliance. The first average amount of electricity consumption and the second average amount of electricity consumption are taken as criteria for determining if the replacing second electric appliance has improved power utilization efficiency for customers. Electric power companies further deduct the incentive amount from the amount of customers' electric bill as a measure of promoting customers' willingness to replace the first electric appliance with the second electric appliance and improve power utilization efficiency.

Other objectives, advantages and novel features of the invention will become more apparent from the following detailed description when taken in conjunction with the accompanying drawings.

### BRIEF DESCRIPTION OF THE DRAWINGS

FIG. 1 is a flow diagram of a first embodiment of an electricity consumption billing method in accordance with the present invention;

FIG. 2 is a functional block diagram of an electricity billing system performing the electricity consumption billing method in FIG. 1;

FIG. 3 is a flow diagram of a second embodiment of an electricity consumption billing method in accordance with the present invention; and

FIGS. 4A and 4B are functional block diagrams associated with another electricity billing system performing the electricity consumption billing method in FIG. 3.

### DETAILED DESCRIPTION OF THE INVENTION

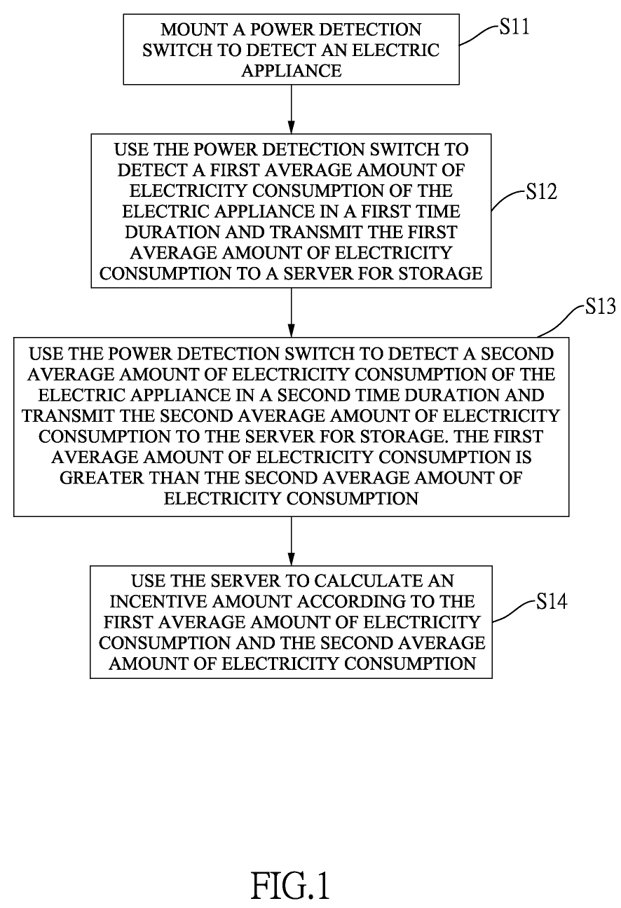

With reference to FIG. 1, a first embodiment of an electricity consumption billing method in accordance with the present invention includes the following steps.

Step S11: Mount a power detection switch to detect an electric appliance.

Step S12: Use the power detection switch to detect a first average amount of electricity consumption of the electric appliance in a first time duration and transmit the first average amount of electricity consumption to a server for storage.

Step S13: Use the power detection switch to detect a second average amount of electricity consumption of the electric appliance in a second time duration and transmit the second average amount of electricity consumption to the server for storage. The first average amount of electricity consumption is greater than the second average amount of electricity consumption.

Step S14: Use the server to calculate an incentive amount according to the first average amount of electricity consumption and the second average amount of electricity consumption.

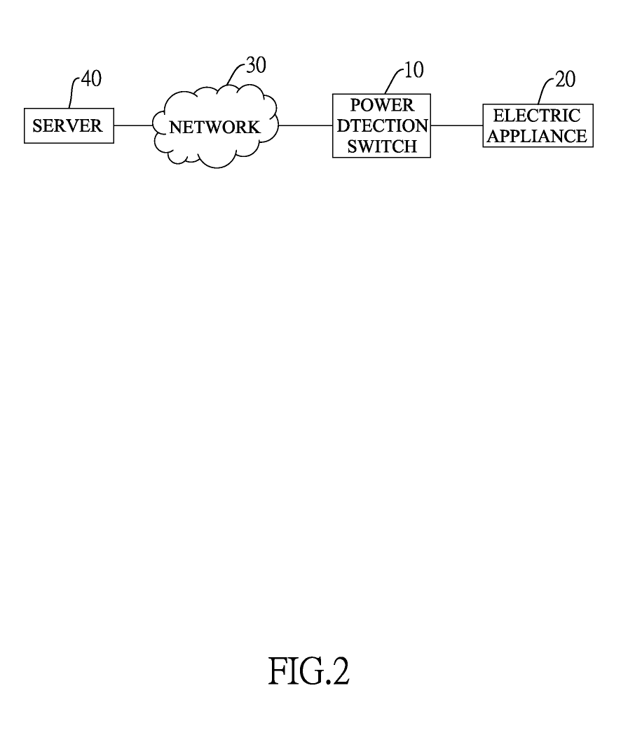

With reference to FIG. 2, an electricity billing system performing the foregoing electricity consumption billing method includes a power detection switch 10, an electric appliance 20, a server 40, and the Internet 30. The power detection switch 10 is connected to the electric appliance 20 and is connected to the server 40 through the Internet 30.

The power detection switch 10 is used to detect power of the electric appliance 20 in step S11, records the first average amount of electricity consumption of the electric appliance 20 during the first time duration in step S12 to exclude the condition when the electric appliance 20 does not consume electricity and to know the exact power utilization efficiency of the electric appliance 20 when customers use the electric appliance 20, and records the second average amount of electricity consumption of the electric appliance 20 during the second time duration in step S13 to determine if the power utilization efficiency of the electric appliance 20 has been improved.

For example, suppose that the first time duration is July and the second time duration is August, and the electric appliance 20 is an air conditioner. The temperature of the air conditioner is respectively set at 22 degrees when customers use the air conditioner in July, and at 25 degrees when customers use the air conditioner in August.

The first average amount of electricity consumption is defined by dividing a total amount of electricity consumed by the air conditioner in the first time duration by a total power-on time of the air conditioner in the first time duration. For example, supposing that the total power-on time of the air conditioner in July is 500 hours and the total amount of electricity consumed by the air conditioner in July is 400 degrees (kilowatt-hour), the first average amount of electricity consumption of the electric appliance 20 in July is expressed by:

$$\frac{400 \times 1000 \times 3600}{500 \times 3600} = 800 W$$

Although there are about 720 hours in one month, the air conditioner does not operate around the clock. Therefore, the total power-on time of the air conditioner in July should be taken as a time basis to accurately calculate the first average amount of electricity consumption.

According to the first average amount of electricity consumption stored in step S12 and the second average amount of electricity consumption stored in step S13, the server 40 calculates the incentive amount.

Suppose that the temperature of the air conditioner is set at 22 degrees in July and the temperature of the air conditioner is set at 25 degrees in August. Thus, the first average amount of electricity consumption in July detected by the power detection switch 10 is 800 watts, and the second average amount of electricity consumption in August detected by the power detection switch 10 is 640 watts. A drop in percentage of average amount of electricity consumption of the air conditioner can be calculated by the following equation after customers set up the temperature of the air conditioner.

$$\frac{A - B}{B} = \frac{800 - 640}{640} = 25 \%$$

where A represents the first average amount of electricity consumption and B represents the second average amount of electricity consumption.

From the foregoing equation, after the temperature of the air conditioner is adjusted from 22 degrees to 25 degrees, the second average amount of electricity consumption of the air conditioner is down by 25% from the first average amount of electricity consumption. Electric power companies can offer an incentive amount according to the drop in percentage to encourage customers to actively improve the power utilization efficiency of the electric appliance 20 or reduce the amount of electricity consumption of the electric appliance 20, thereby lowering electricity consumption during the on-peak hours. For example, electric power companies can detect a total amount of electricity consumption of the air conditioner in July (first time duration), which is 4,000 degrees (kilowatts-hours) through the power detection switch 10, each degree is charged for four dollars, and the electric bill for the air conditioner in July is 1,600 dollars. Furthermore, the second average amount of electricity consumption of the air conditioner in August (second time duration) calculated by the electric power companies has a drop in percentage 25% relative to the first average amount of electricity consumption in July and is equal to 300 degrees and the electric bill for the air conditioner in August is 1,200 dollars. From the perspective of customers, after the temperature of the air conditioner is adjusted, not only does the electric bill drop from 1,600 dollars to 1,200 dollars, but also the electric power companies offer additional incentive amount, which is (25/2)%=12.5% of the amount on the current time duration (August) and is 1200×12.5%=150 dollars. Customers are originally supposed to pay 1,200 dollar for the electric bill in August while only 1050 dollar needs to be paid after the rebate of the incentive amount, 150 dollars. Accordingly, customers can improve power utilization efficiency to reduce electricity consumption, keep the payment of electric bill down, and receive additional incentive amount from the electric power companies at the same time to increase customers' willingness in support of improvement on power utilization efficiency.

The incentive amount can be calculated according to the following equation.

$$\frac{A - B}{B} \times \frac{1}{2} \times C = D$$

where

A is the first average amount of electricity consumption;

B is the second average amount of electricity consumption;

C is the amount of electric bill of the electric appliance 20 for the second time duration;

D is the incentive amount.

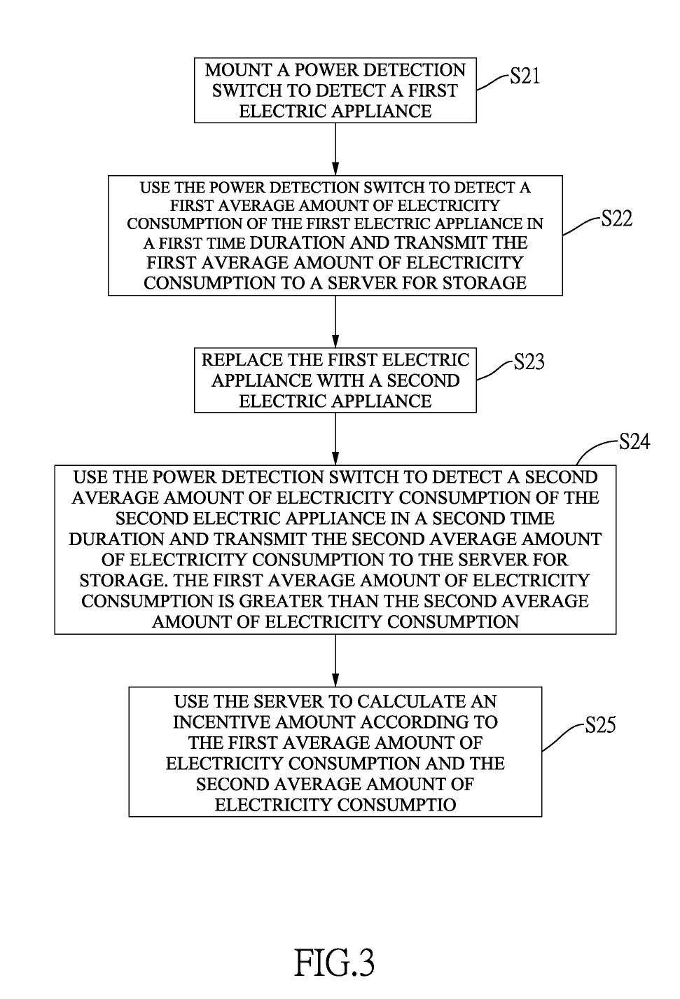

With reference to FIG. 3, a second embodiment of an electricity consumption billing method in accordance with the present invention includes the following steps.

Step S21: Mount a power detection switch to detect a first electric appliance.

Step S22: Use the power detection switch to detect a first average amount of electricity consumption of the first electric appliance in a first time duration and transmit the first average amount of electricity consumption to a server for storage.

Step S23: Replace the first electric appliance with a second electric appliance.

Step S24: Use the power detection switch to detect a second average amount of electricity consumption of the second electric appliance in a second time duration and transmit the second average amount of electricity consumption to the server for storage. The first average amount of electricity consumption is greater than the second average amount of electricity consumption.

Step S25: Use the server to calculate an incentive amount according to the first average amount of electricity consumption and the second average amount of electricity consumption.

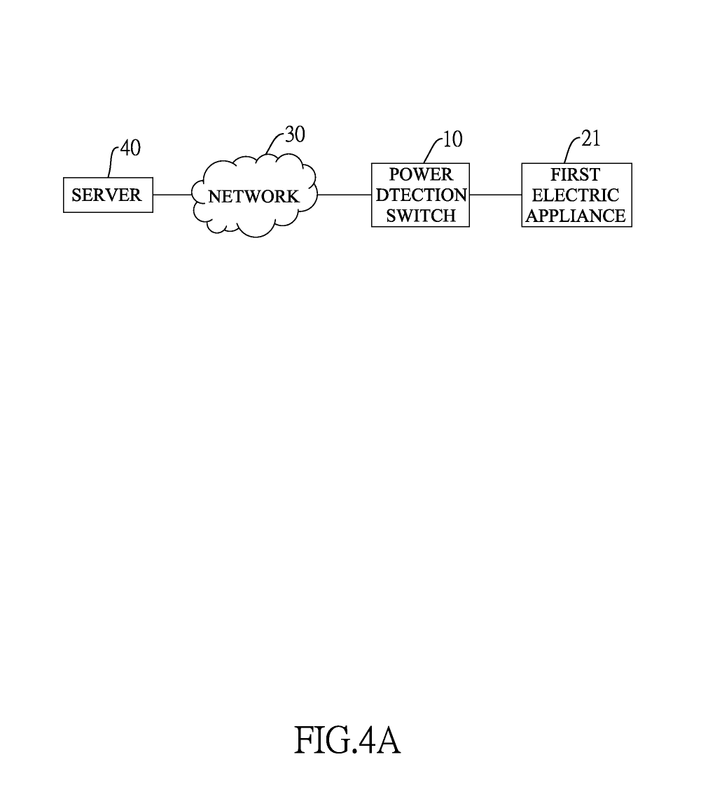

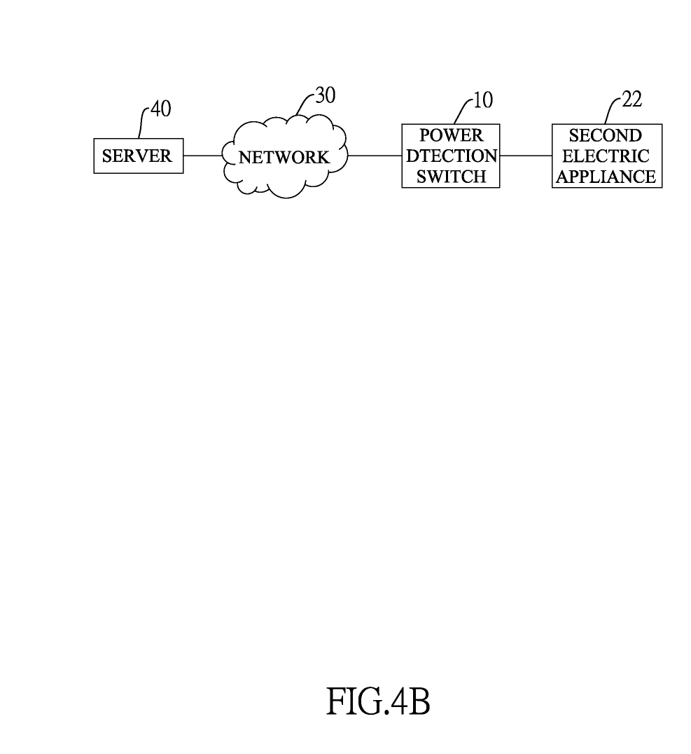

With reference to FIG. 4A, in step S21, supposing that the first electric appliance 21 is a conventional light, the power detection switch 10 is used to turn on or off the conventional light and detect power of the conventional light. In step S22, supposing that the first time duration is January, the power detection switch 10 detects the first average amount of electricity consumption of the conventional light in January to exclude the condition when the conventional light does not consume electricity and to know the exact power utilization efficiency of the conventional light when customers use the conventional light.

The first average amount of electricity consumption is defined by dividing a total amount of electricity consumed by the conventional light in the first time duration by a total power-on time of the conventional light in the first time duration. For example, supposing that the total power-on time of the conventional light in January is 250 hours and the total amount of electricity consumed by the conventional light in January is 100 degrees (kilowatt-hour), the first average amount of electricity consumption of the conventional light in January is expressed by:

$$\frac{100 \times 1000 \times 3600}{250 \times 3600} = 400 W$$

Although there are about 720 hours in one month, the conventional light is not turned on around the clock. Therefore, the total power-on time of the conventional light in January should be taken as a time basis to accurately calculate the first average amount of electricity consumption.

With reference to FIG. 4B, in step S23, the second electric appliance 22 is a light-emitting diode (LED) lamp such that the conventional light (the first electric appliance 21) is replaced by the LED lamp (the second electric appliance 22). As the amount of power consumption of the LED lamp is lower than that of the conventional light or has equivalent or better lighting effect, the LED lamp has a higher power utilization efficiency and can thus save more electricity. Therefore, when customers intend to replace the conventional light with the LED lamp, electric power companies can offer the customers a substantive incentive amount to encourage the customers for selection of the LED lamp and improvement on power utilization efficiency.

In step S24, supposing that the second time duration is February, as the conventional light is replaced by the LED lamp, the power detection switch 10 is used to detect the second average amount of electricity consumption of the LED lamp, which is uncorrelated to the length of power-off time of the LED lamp. Hence, the first average amount of electricity consumption and the second average amount of electricity consumption are also uncorrelated to the lengths of the first time duration and the second time duration. However, the conventional lamp relatively consumes more power than the LED lamp, such that the first average amount of electricity consumption of the conventional light is greater than the second average amount of electricity consumption of the LED lamp.

In step S25, supposing that the first average amount of electricity consumption detected by the power detection switch 10 is 400 watts, a total amount of electricity consumption of the air conditioner consumed in January (first time duration) is 100 degrees (kilowatts-hours), and each degree is charged for four dollars, the electric bill for the conventional light in January is 400 dollars. After the conventional light is replaced with the LED lamp, supposing that the second average amount of electricity consumption detected by the power detection switch 10 is 200 watts, a total amount of electricity consumption of the LED lamp consumed in February (second time duration) is 40 degrees (kilowatts-hours), and each degree is charged for four dollars, the electric bill for the conventional light in January is 160 dollars. A drop in percentage of average amount of electricity consumption can be calculated by the following equation after the conventional light is replaced by the LED lamp.

$$\frac{A - B}{B} = \frac{400 - 200}{200} = 100 \%$$

where A represents the first average amount of electricity consumption and B represents the second average amount of electricity consumption.

From the foregoing equation, after the conventional light is replaced by the LED lamp, the second average amount of electricity consumption is down by 100% from the first average amount of electricity consumption. Electric power companies can offer an incentive amount according to the drop in percentage to encourage customers to actively select the LED lamp or reduce the amount of electricity consumption, thereby lowering electricity consumption. For example, when electric power companies calculate the electric bill according to the drop in percentage 100%, the electric bill is calculated based on the total amount of electricity consumption of the LED lamp in February and an incentive amount (100/2)%=50% is offered. Thus, after customers select the LED lamp, customers only pay 160 dollars instead of the original 400 dollars, and electric power companies further offer a one-time incentive amount to encourage customers to choose the LED lamp. The incentive amount is 50% of the amount of the electric bill, that is, 80 dollars. After customers select the LED lamp, not only does the amount of the electric bill in February go down to 160 dollars, but also additional incentive amount 80 dollars is offered as a credit on the electric bill. In other words, customers only need to pay 160−80=80 dollars for the electric bill.

The incentive amount can be calculated according to the following equation.

$$\frac{A - B}{B} \times \frac{1}{2} \times C = D$$

where

A is the first average amount of electricity consumption;

B is the second average amount of electricity consumption;

C is the amount of electric bill of the second electric appliance 22 for the second time duration;

D is the incentive amount.

Accordingly, customers can improve power utilization efficiency to reduce electricity consumption, keep the payment of electric bill down, and receive additional incentive amount from the electric power companies at the same time to increase customers' willingness in support of improvement on power utilization efficiency.

Additionally, electric power companies can further continuously monitor customers through the power detection switch to observe if the customers further switch the LED lamp back to the conventional light after selecting the LED lamp and receiving the incentive amount, and all it takes is to detect the average amount of electricity consumption of the replacing electric appliance through the power detection switch 10. In other words, when the average amount of electricity consumption detected by the power detection switch 10 is 200 watts, it indicates that the customer is still using the LED lamp, and when the average amount of electricity consumption detected by the power detection switch 10 is 400 watts, it indicates that the customer has switched back to the conventional light.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An electricity consumption billing method, comprising steps of:
mounting a power detection switch to detect an electric appliance;
using the power detection switch to detect a first average amount of electricity consumption of the electric appliance in a first time duration and transmitting the first average amount of electricity consumption to a server for storage;
using the power detection switch to detect a second average amount of electricity consumption of the electric appliance in a second time duration and transmitting the second average amount of electricity consumption to the server for storage, wherein the first average amount of electricity consumption is greater than the second average amount of electricity consumption; and
using the server to calculate an incentive amount according to the first average amount of electricity consumption and the second average amount of electricity consumption.

2. The electricity consumption billing method as claimed in claim 1, wherein the incentive amount is calculated according to an equation as follows:
$$\frac{A - B}{B} \times \frac{1}{2} \times C = D$$
where
A is the first average amount of electricity consumption;
B is the second average amount of electricity consumption;
C is an amount of an electric bill of the electric appliance for the second time duration; and
D is the incentive amount.

3. The electricity consumption billing method as claimed in claim 1, wherein the first average amount of electricity consumption is calculated by an equation as follows:
$$P 1 = \frac{E 1}{T 1}$$
where
P1 is the first average amount of electricity consumption;
E1 is a total amount of electricity consumed by the electric appliance in the first time duration; and
T1 is a total power-on time of the electric appliance in the first time duration.

4. An electricity consumption billing method, comprising steps of:
mounting a power detection switch to detect a first electric appliance;
using the power detection switch to detect a first average amount of electricity consumption of the first electric appliance in a first time duration and transmitting the first average amount of electricity consumption to a server for storage;
replacing the first electric appliance with a second electric appliance;
using the power detection switch to detect a second average amount of electricity consumption of the second electric appliance in a second time duration and transmitting the second average amount of electricity consumption to the server for storage, wherein the first average amount of electricity consumption is greater than the second average amount of electricity consumption; and
using the server to calculate an incentive amount according to the first average amount of electricity consumption and the second average amount of electricity consumption.

5. The electricity consumption billing method as claimed in claim 4, wherein the incentive amount is calculated according to an equation as follows:
$$\frac{A - B}{B} \times \frac{1}{2} \times C = D$$
where
A is the first average amount of electricity consumption;
B is the second average amount of electricity consumption;
C is an amount of an electric bill of the second electric appliance for the second time duration; and
D is the incentive amount.

6. The electricity consumption billing method as claimed in claim 4, wherein the first average amount of electricity consumption is calculated by an equation as follows:
$$P 1 = \frac{E 1}{T 1}$$
where
P1 is the first average amount of electricity consumption;
E1 is a total amount of electricity consumed by the first electric appliance in the first time duration; and
T1 is a total power-on time of the first electric appliance in the first time duration.
